(19) United States
(12) Patent Application Publication
(10) Pub. No.: US 2018/0111070 A1
(43) Pub. Date: Apr. 26, 2018

(54) BYPASS FOR HIGH DEMAND PERIODS FOR WATER PURIFICATION SYSTEM

(71) Applicant: DS SERVICES OF AMERICA, INC., Atlanta, GA (US)

(72) Inventor: Bruce D. Burrows, Valencia, CA (US)

(73) Assignee: DS SERVICES OF AMERICA, INC., Atlanta, GA (US)

(21) Appl. No.: 15/792,913

(22) Filed: Oct. 25, 2017

Related U.S. Application Data
(60) Provisional application No. 62/412,795, filed on Oct. 25, 2016.

(51) Int. Cl. B01D 35/147

(52) U.S. Cl. CPC B01D 35/147; B01D 61/022

(57) ABSTRACT

A water purification system that allows for bypassing one or more stages of purification during periods of high demand. Bypass can be selectively implemented as a function of fluid particulate levels and/or reservoir level.

### CROSS-REFERENCE TO RELATED APPLICATION

This application claims the benefit of U.S. provisional application Ser. No. 62/412,795 filed on Oct. 25, 2016 and entitled BYPASS FOR HIGH DEMAND PERIODS FOR WATER PURIFICATION SYSTEM, the content of which is herein incorporated by reference in its entirety.

### BACKGROUND

### Field

Aspects of the present disclosure generally relate to apparatuses and methods for water purification. More specifically, the present disclosure relates to apparatuses configured with a bypass conduit for use during high demand periods in water purification systems.

### Background

Water is necessary for human existence. In many parts of the world, clean drinking water is difficult to obtain. Many different types of water purification systems and methods have been employed to produce clean drinking water throughout the world.

Although many municipal water systems provide clean and/or purified drinking water, filtration systems have become popular in many offices and homes. These filtration systems often employ a filter of particulates contained within an in-line canister to trap, adsorb, and/or otherwise remove certain chemicals and/or other dissolved solids from the incoming water stream. These filters may employ carbon, activated carbon, or other materials to adsorb, catalyze, and/or otherwise treat the incoming water. Filtration systems may also optionally employ a reverse osmosis filter, either in addition to the particulate filter or instead of the particulate filter, to purify an incoming water supply.

In some filtration systems, a reservoir of purified water may be present to store purified water for on-demand use. Reverse osmosis systems may only generate one gallon of purified water per hour, and as such, a reservoir of purified water may be useful to allow for periods of heavy demand. However, once the reservoir is emptied, the water purification system may not be able to provide purified water for an extended period of time.

### SUMMARY

The present disclosure describes a water purification system that allows for a bypass of one or more stages of water purification. During periods of high demand, the bypass may allow water to be delivered without passing through all of the stages of the water purification system. In one configuration the purification system comprises a first filter comprising a particulate filter, and having an inlet and an outlet, and a second filter comprising a reverse osmosis filter, and having an inlet and at least a first outlet. A reservoir holds fluid, such as water, the reservoir having an inlet and an outlet. A bypass valve is positioned between the outlet of the first filter, the inlet of the second filter and the inlet of the reservoir. The bypass valve has a first position wherein the bypass valve provides fluid communication between the outlet of the first filter and the inlet of the second filter, and the bypass valve has a second position wherein the bypass valve provides fluid communication between the outlet of the first filter and the inlet of the reservoir, bypassing the inlet of the second filter. A controller controls position of the bypass valve between at least the first position and the second position.

The fluid purification system may further comprise a level sensor in communication with the controller and wherein level sensor information provided to the controller determines whether the bypass valve is in the first position or the second position. Further, the fluid purification system may further comprise a particulate sensor in communication with the controller and particulate sensor information provided to the controller may determine whether the bypass valve is in the first position or the second position.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates a block diagram of a water purification system in accordance with an aspect of the present disclosure; and

FIG. 2A illustrates a reservoir in accordance with an aspect of the present disclosure.

FIG. 2B illustrates an alternative embodiment of a reservoir in accordance with an aspect of the present disclosure, incorporating a particulate sensor interacting with a controller to control actuation of a bypass valve.

FIG. 3 illustrates a block diagram of bypass valve control in the embodiment of FIG. 2B.

FIG. 4 illustrates a flow diagram for operation of the controller of FIG. 2B reservoir in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

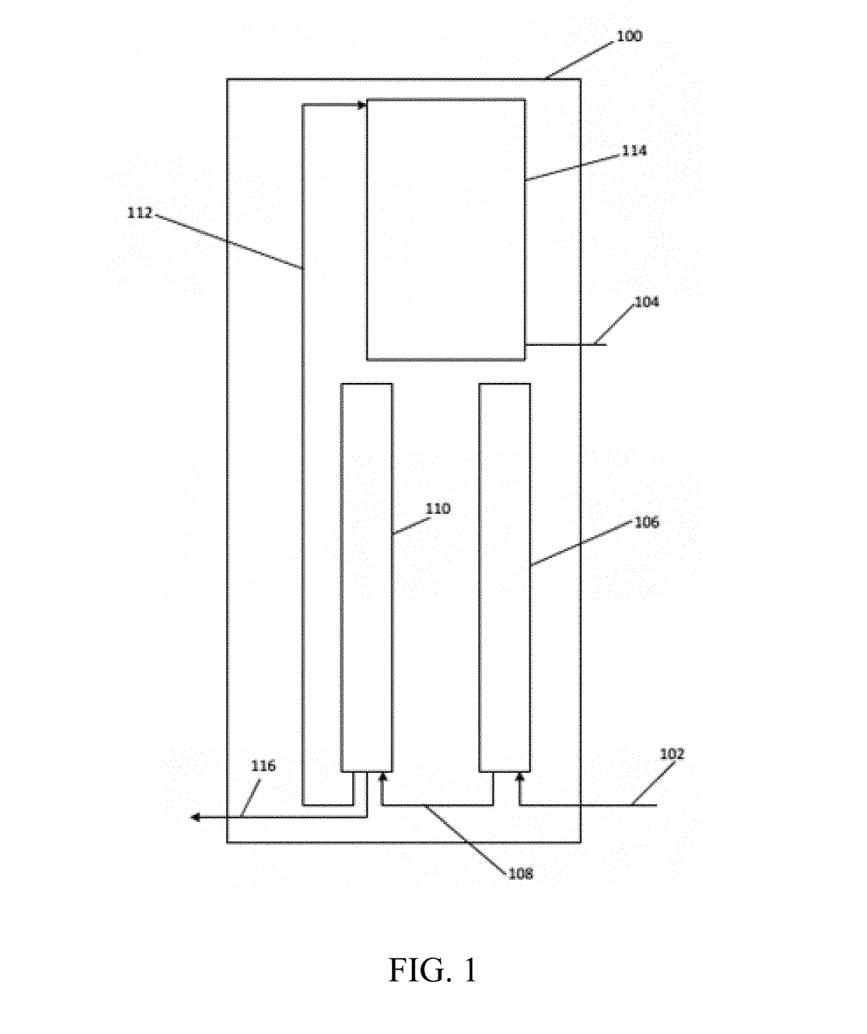

FIG. 1 illustrates a block diagram of a water purification system in accordance with an aspect of the present disclosure. System 100 comprises an inlet line 102 and an outlet 104. Inlet line 102 may be coupled to filter 106, which is coupled by line 108 to filter 110. Filter 110 is coupled by line 112 to reservoir 114. Filter 110 also may have a brine (drain) line 116.

Inlet line 102 may be a pipe and/or other connection to a municipal water supply. Outlet 104 may be a faucet, spigot, tap, and/or other selectively controllable valve to permit the flow of fluid from reservoir 114. Inlet line 102, line 108, and line 112 may be conduits, tubes, and/or other piping to connect the various components within system 100. Other components may also be included in system 100 without departing from the scope of the present disclosure. Such optional additional components may include compressors, heating elements, valves, controllers, etc., depending on the complexity and application of system 100 in a particular environment.

Filter 106 may be a particulate filter. For example, and not by way of limitation, filter 106 may remove particulates, e.g., dirt, sand, etc., from the fluid flowing into system 100 from the inlet line 102. Filter 106 may, alternatively and/or in addition, remove dissolved solids from the fluid flowing into system 100 from the inlet line 102. For example, and not by way of limitation, filter 106 may comprise carbon particles that remove chlorine and chloramines from the fluid flowing in inlet line 102 via adsorption. Additives may be placed within filter 106 to catalyze certain dissolved solids from the fluid flowing into system 100. Other chemical, electrical, and/or mechanical methods may be employed within filter 106 to remove solids and/or dissolved solids from the fluid entering system 100 via inlet line 102 without departing from the scope of the present disclosure.

Filter 110 may be a reverse osmosis filter. A reverse osmosis filter removes other dissolved solids from the fluid in the inlet line 102 by passing the fluid through a porous membrane. When the pressure passing the fluid through the membrane (the hydrostatic pressure) is greater than the pressure required for particles to flow through the membrane (the osmotic pressure), the dissolved solids pass through the membrane in a “reverse” direction away from the fluid flow.

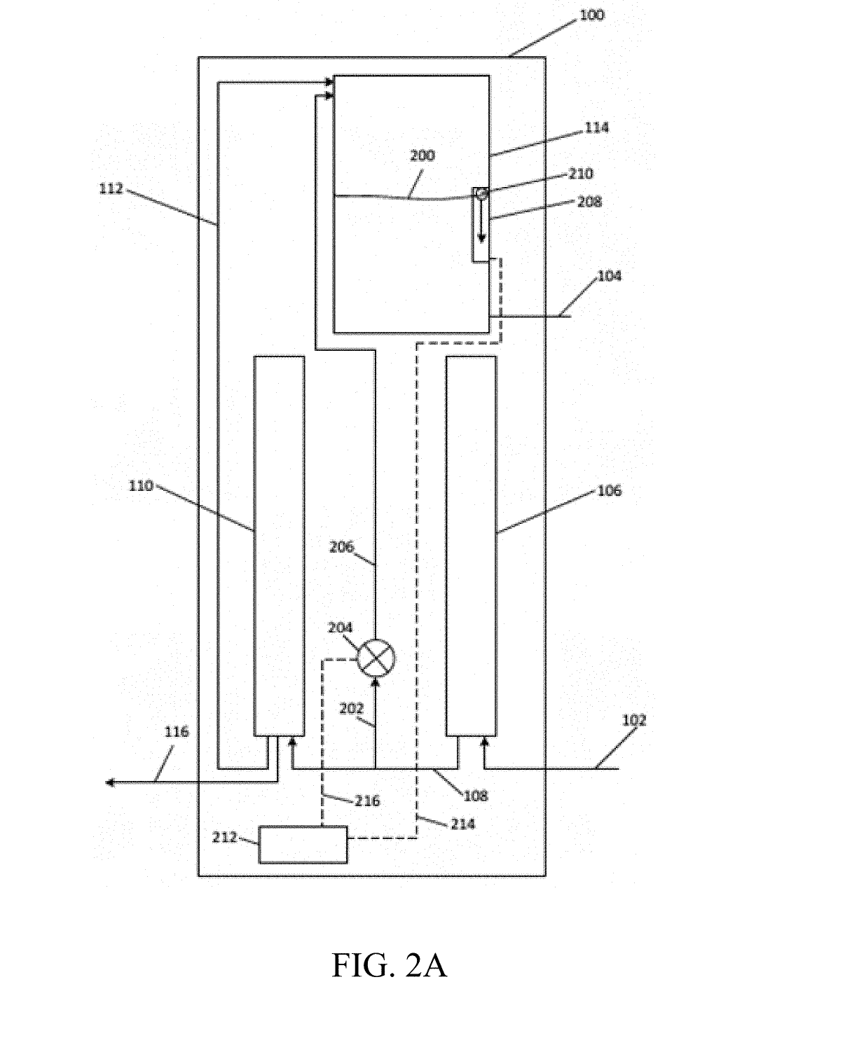

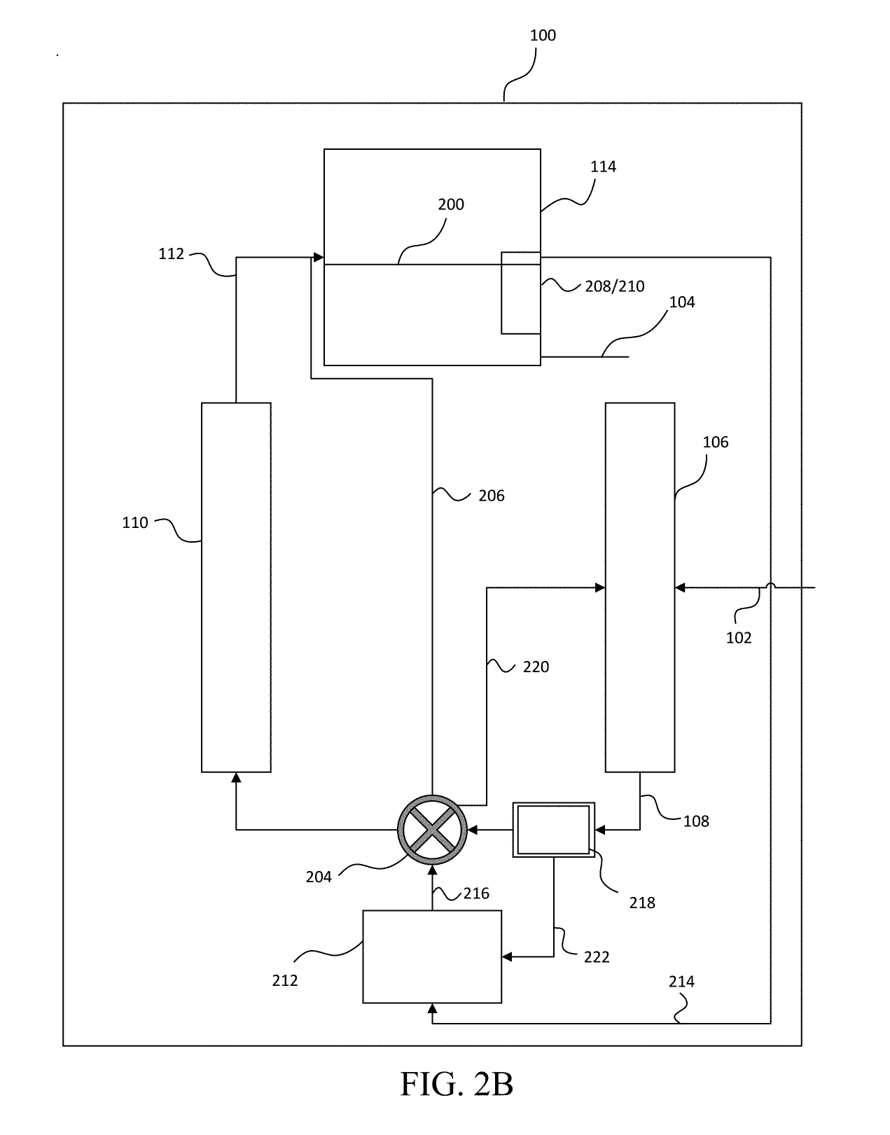

FIG. 2A illustrates a reservoir in accordance with an aspect of the present disclosure. Under periods of high demand, the fluid 200 level in reservoir 114 may fall to a level where no fluid 200 remains in reservoir 114. In an aspect of the present disclosure, system 100 may include a bypass conduit 202 that is coupled to a valve 204, which delivers fluid that has passed through filter 106 to conduit 206, bypassing filter 110. Conduit 206 delivers this fluid to reservoir 114.

To control valve 204, which may be a solenoid valve, a switch 208, with a float 210 is coupled to a controller 212 by control line(s) 214. Controller 212 is also coupled to valve 204 by control line(s) 216. When switch 208 changes state (e.g., from open to closed or from closed to open), controller opens valve 204 to allow fluid to flow through conduits 202 and 206. Because filter 106, which may be a filter that removes particulates and/or some dissolved solids, can produce purified water faster than filter 110, which may be a reverse osmosis filter, the water passing through conduits 202 and 206 can be delivered to output 104 during periods of high demand.

Switch 208 may be mounted anywhere on or in reservoir 114, and may measure the fluid 200 level in reservoir 114 in any number of ways. For example, and not by way of limitation, switch 208 may be an optical switch, with a transmitter and receiver, and change state when fluid 200 level drops to a certain predetermined level within reservoir 114. Switch 208 may be a float switch, reed relay, or any type of switch or device that can change state based on the level of fluid 200 in reservoir 114 without departing from the scope of the present disclosure.

Controller 212 may control valve 204 by time, e.g., may only open valve 204 for a certain amount of time. Controller 212 may control valve 204 by switch 208, e.g., open valve 204 when switch 208 is in one state (e.g. when float 210 reaches the bottom of switch 208) and close valve 204 when switch 208 is in another state (e.g., when float 210 reaches the top of switch 208). Controller 212 may combine control methods and/or devices to control when valve 204 is open and when valve 204 is closed. Any combination of controls for valve 204 are possible within the scope of the present disclosure.

In regards to the reservoir water level indicator 208/210, it should be noted that a variety of different sensors and techniques can be used to measure the relative amount of water left in the reservoir. In one instance a load cell may be used to determine the percent volume of water left in the reservoir based on the relative weight of the remaining fluid. In other embodiments simple sensors such as Infrared emitters and receivers or Ultrasonic emitters and receivers may be used to accurately determine the amount of water left in a reservoir. In a separate embodiment, without using any sensors for the water level indicator, the weight of the water in the reservoir can be used to hold closed the bypass valve which will open when the amount of water in the reservoir falls below a certain threshold value indicating that there is not enough water to hold the valve closed.

In another embodiment of the invention, illustrated in FIG. 2B, the controller 212 can be configured for different operational cases. In the illustrated embodiment, a feedback line 220 is implemented that will feed the water back into the particle filter 106 in the event that a particulate sensor 218 returns an unacceptable reading to the controller 212 of opacity for the water, or in the event that further first stage filtering is desired as an alternative to second stage filtering. In this embodiment the controller 212 will be able to control three states of the bypass valve 204 activating it to open, remain closed, or feedback the water. Accordingly, water may be filtered through the particle filter 106 one or more times, as a function of the level of particles in the water output from the particle filter 106, such that the water can be filtered in high demand situations primarily by the particle filter rather than a stage of filtering through the RO filter 110 (e.g. so as to avoid the delay of filtration by the RO filter required to keep the reservoir 114 filled to an acceptable/useful level).

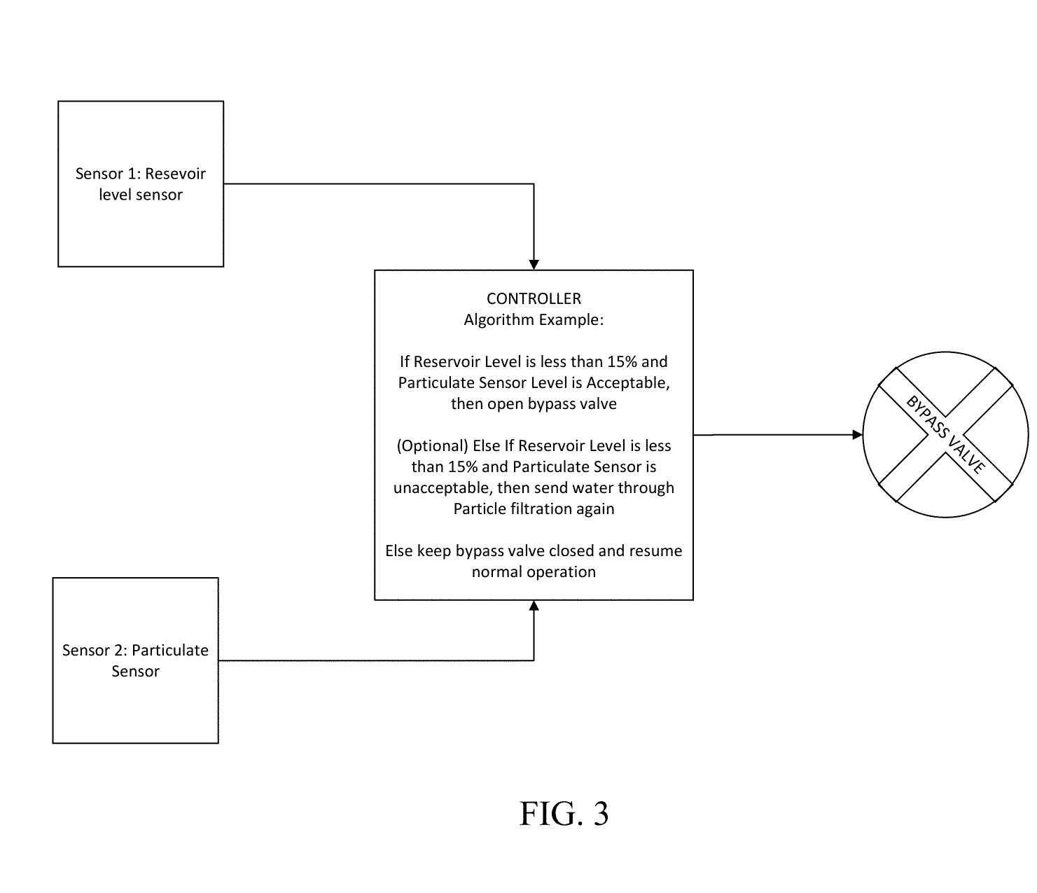

FIG. 3 illustrates a block diagram of the embodiment of FIG. 2B. As illustrated, a first sensor, a reservoir level sensor, is in communication with the controller 212. Similarly, a second sensor, a particulate sensor (or multi-parameter water quality monitor) as known in the art, is in communication with the controller 212. For example, the first and second sensors may be in digital or analog electronic communication (wired or wireless) with the controller 212. The controller 212 may be programmed or configured to perform an algorithm or steps of operation that monitor the level of the fluid in the reservoir and monitor a parameter of the fluid in the reservoir (such as opacity or particle count). If the reservoir level is less than a specified amount or within a range, then the controller 212 may open the bypass valve 204 and route fluid to the reservoir rather than to the RO filter 110.

Optionally or alternatively, if the fluid level is less than a specified level (which may be different from the level for determining routing to the reservoir (i.e. bypassing RO filtration), the controller may control the valve 204 to route fluid back through the particulate filter 106 (e.g. for multiple passes of particulate filtration that may take less time to restore appropriate levels in the reservoir than would RO filtration). Otherwise, the bypass valve 204 will route fluid in the normal path of operation, i.e. from the particle filtration to the RO filtration to the reservoir. The controller may also, as a function of particulate level, shut the system down so there is no further flow to the reservoir, for example if particulate levels are at an unacceptably high level.

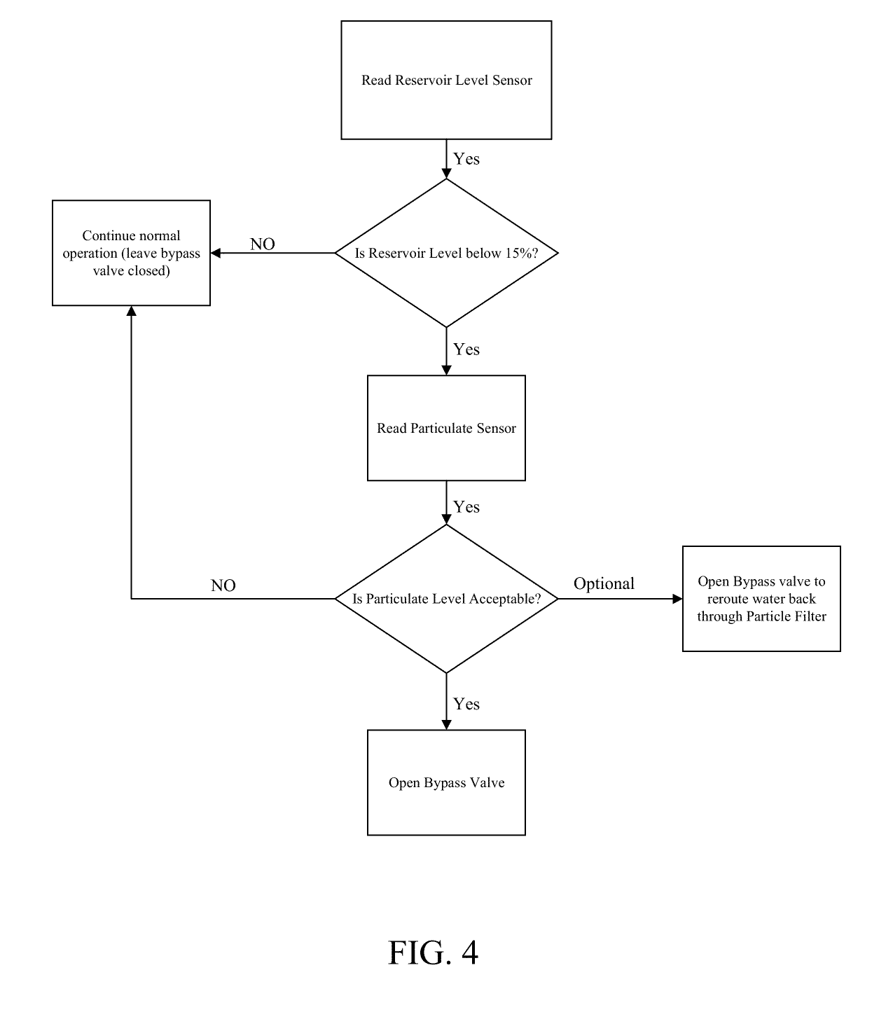

FIG. 4 provides an illustrative algorithm that may be implemented in software code for implementation with the controller 212 in the embodiment of FIGS. 2B and 3. In the illustrated process, the reservoir level is monitored. As long as the reservoir level is at an acceptable level, normal 2-stage operation continues. Particulate level may also be monitored and as long as the reservoir level is acceptable and particulate level is such that 2-stage filtering is desirable then normal 2-stage operation may continue. If the reservoir level is below a selected threshold (or within a range), fluid may be either routed directly to the reservoir via the bypass valve in order to restore fluid level or it may be routed via the feedback path for first-stage, particulate filtering (one or more times). Particulate level may be monitored such that in the case where reservoir level is unacceptable, particulate level will be used to determine whether fluid is routed directly to the reservoir or feedback for further first stage filtering. It should be noted that the levels illustrated in the figures are illustrative and do not necessarily reflect operating parameters or the limitations of the present invention.

The memory of controller 212, which may be internal memory and/or external memory, may be implemented in firmware and/or software implementation. The firmware and/or software implementation methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit (e.g., controller 212). Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to components. Of course, if the component is inverted, above becomes below, and vice versa. Additionally, if oriented sideways, above and below may refer to sides of a component. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. A fluid purification system comprising:
a first filter comprising a particulate filter, and having an inlet and an outlet;
a second filter comprising a reverse osmosis filter, and having an inlet and at least a first outlet;
a reservoir to hold fluid, the reservoir having an inlet and an outlet;
a bypass valve positioned between the outlet of the first filter, the inlet of the second filter and the inlet of the reservoir, and having a first position wherein the bypass valve provides fluid communication between the outlet of the first filter and the inlet of the second filter, and having a second position wherein the bypass valve provides fluid communication between the outlet of the first filter and the inlet of the reservoir, bypassing the inlet of the second filter; and
a controller controlling position of the bypass valve between at least the first position and the second position.

2. The fluid purification system of 1, further comprising a level sensor in communication with the controller and wherein level sensor information provided to the controller determines whether the bypass valve is in the first position or the second position.

3. The fluid purification system of claim 1, further comprising a particulate sensor and a level sensor in communication with the controller and wherein at least one of particulate sensor information or level sensor information provided to the controller determines whether the bypass valve is in the first position or the second position.

4. The fluid purification system of claim 1, further comprising a particulate sensor in communication with the controller and wherein particulate sensor information provided to the controller determines whether the bypass valve is in the first position or the second position.

5. The fluid purification system of claim 1, further comprising a feedback path from the bypass valve to the first filter.

6. The fluid purification system of claim 5, wherein the bypass valve has a third position wherein the bypass valve provides fluid communication between the outlet of the first filter and the feedback path to the first filter.

7. The fluid purification system of claim 1, wherein the outlet of the reservoir comprises a faucet, spigot, tap, or other valve that controllably permits a flow of the fluid from the reservoir.

8. The fluid purification system of claim 1, the second filter having a second outlet via which brine exits the reverse osmosis filter.

9. The fluid purification system of claim 1, wherein the particulate filter comprises carbon particles to remove chlorine and chloramines from the fluid by adsorption, and an additive to catalyze dissolved solids, and
wherein the reverse osmosis filter comprises a porous membrane through which fluid pass from the inlet of the second filter to the outlet of the second filter.

10. The fluid purification system of claim 1, wherein the fluid is water.

11. A fluid purification method comprising:
filtering fluid through a first filter;
delivering the fluid to a bypass valve disposed after the first filter;
depending on a position of the bypass valve, filtering the fluid through a second filter or flowing the fluid into a reservoir after filtering the fluid through the first filter.

12. The fluid purification method of claim 11, further comprising:
sensing a level of fluid in the reservoir, and determining whether to filter the fluid through the second filter or flow the fluid into the reservoir after filtering the fluid through the first filter, depending on the level of fluid in the reservoir.

13. The fluid purification method of claim 11, further comprising:
sensing a parameter of fluid flowing from the first filter, and determining whether to filter the fluid through the second filter or flow the fluid into the reservoir after filtering the fluid through the first filter, depending on the parameter of the fluid.

14. The fluid purification method of claim 13, wherein the parameter is a level of particulates in the fluid.

15. A fluid purification method for fluid to be stored in a reservoir, comprising:
filtering fluid through a first filter;
delivering the fluid to a bypass valve disposed after the first filter;
sensing a level of fluid in the reservoir;
determining whether to filter the fluid through a second filter or flow the fluid into the reservoir after filtering the fluid through the first filter, depending on the level of fluid in the reservoir.
depending on a position of the bypass valve, filtering the fluid through a second filter or flowing the fluid into a reservoir after filtering the fluid through the first filter.

16. The fluid purification method of claim 15, further comprising:
sensing a level of particles in fluid filtered through the first filter; and
determining whether to filter the fluid through a second filter or flow the fluid into the reservoir after filtering the fluid through the first filter, depending on the level of particles in the fluid.

17. The fluid purification method of claim 15, further comprising:
controlling a flow of the fluid into the reservoir based on at least one of a level of fluid in the reservoir and a level of particles in fluid flowing out of the first filter.

18. The fluid purification method of claim 15, wherein the first filter is a particulate filter.

19. The fluid purification method of claim 15, wherein the second filter is a reverse osmosis filter.

20. The fluid purification method of claim 15, wherein filtering the fluid through the first filter comprises filtering the fluid through carbon particles to remove chlorine and chloramines from the fluid by adsorption, and catalyzing first dissolved solids; and
filtering the fluid through the second filter comprises reverse osmosis filtering to remove second dissolved solids from the fluid.
